(19) United States
(12) Patent Application Publication
(10) Pub. No.: US 2025/0247692 A1
(43) Pub. Date: Jul. 31, 2025

(54) SECURITY FOR MOBILE-TO-MOBILE POSITIONING

(71) Applicant: QUALCOMM Incorporated, San Diego, CA (US)

(72) Inventors: Soo Bum LEE, San Diego, CA (US); Haris ZISIMOPOULOS, London (GB); Dan VASSILOVSKI, Del Mar, CA (US); Hong CHENG, Basking Ridge, NJ (US)

(21) Appl. No.: 18/855,399

(22) PCT Filed: May 12, 2023
(86) PCT No.: PCT/US2023/021977

§ 371 Date: Oct. 9, 2024

(30) Foreign Application Priority Data
Jun. 16, 2022 (GR) 20220100499

(51) Int. Cl. H04W 12/041; H04W 8/00; H04W 12/069; H04W 64/00

(52) U.S. Cl. CPC H04W 12/041; H04W 8/005; H04W 12/069; H04W 64/00

(57) ABSTRACT

A positioning session signaling method includes: obtaining, at a first wireless communication device, first security material comprising a ranging cryptographic key, or one or more cryptographic certificates, or a combination thereof; and transmitting, from the first wireless communication device to a second wireless communication device, a ranging signal that is based on at least a first portion of the first security material, or based on second security material, or a combination thereof.

### CROSS-REFERENCE TO RELATED APPLICATIONS

This application claims the benefit of Greek Patent Application Ser. No. 20220100499, filed Jun. 16, 2022, entitled “SECURITY FOR MOBILE-TO-MOBILE POSITIONING,” which is assigned to the assignee hereof, and the entire contents of which are hereby incorporated herein by reference for all purposes.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax®), a fifth-generation (5G) service (e.g., 5G New Radio (NR)), etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

An example first wireless communication device includes: a transceiver; a memory; and a processor, communicatively coupled to the transceiver and the memory, configured to: obtain first security material comprising a ranging cryptographic key, or one or more cryptographic certificates, or a combination thereof; and transmit, via the transceiver to a second wireless communication device, a ranging signal that is based on at least a first portion of the first security material, or based on second security material, or a combination thereof.

An example positioning session signaling method includes: obtaining, at a first wireless communication device, first security material comprising a ranging cryptographic key, or one or more cryptographic certificates, or a combination thereof; and transmitting, from the first wireless communication device to a second wireless communication device, a ranging signal that is based on at least a first portion of the first security material, or based on second security material, or a combination thereof.

Another example first wireless communication device includes: means for obtaining first security material comprising a ranging cryptographic key, or one or more cryptographic certificates, or a combination thereof; and means for transmitting, to a second wireless communication device, a ranging signal that is based on at least a first portion of the first security material, or based on second security material, or a combination thereof.

An example non-transitory, processor-readable storage medium includes processor-readable instructions configured to cause a processor of a first wireless communication device to: obtain first security material comprising a ranging cryptographic key, or one or more cryptographic certificates, or a combination thereof; and transmit, to a second wireless communication device, a ranging signal that is based on at least a first portion of the first security material, or based on second security material, or a combination thereof.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of an example server, various embodiments of which are shown in FIG. 1.

FIG. 5 is a simplified block diagram of an example user equipment.

FIG. 6 is a simplified block diagram of an example network entity.

FIG. 7 is a diagram of a simplified environment for sidelink positioning.

FIG. 8 is a signaling and process flow for sidelink positioning.

FIG. 9 is a signaling and process flow for network assisted/managed group formation and broadcast or unicast sidelink positioning.

FIG. 10 is a signaling and process flow for user equipment based group formation and broadcast or unicast sidelink positioning.

FIG. 11 is a block flow diagram of a positioning session signaling method.

### DETAILED DESCRIPTION

Techniques are discussed herein for providing security (e.g., confidentiality and/or integrity) to positioning between wireless devices (e.g., sidelink positioning). One or more of the wireless devices may be a mobile wireless communication device, which may be called a user equipment (UE), and may store security material such as one or more cryptographic keys (symmetric and/or asymmetric keys) and/or one or more digital certificates. While the discussion herein focuses on mobile wireless communication devices, the discussion applies to use of one or more non-mobile devices (e.g., a Roadside Unit (RSU)). Security material may be stored in the mobile wireless communication device during manufacture and/or after manufacture, e.g., by being received from another wireless communication device such as downloaded from a network entity or received from another UE. The UE may discover one or more other UEs using confidentiality-protected communications (that are encrypted using a cryptographic key of, or derived from, the security material) and/or integrity-protected communications (that are cryptographically signed and/or that include a cryptographic signature), although discovery messaging is optional. The UE may engage in ranging with another UE through messages and positioning reference signal (PRS) transfer where the messages and/or PRS are confidentiality and/or integrity protected. For example, positioning signals (including positioning messages) may be encrypted using a cryptographic key that is included in the security material or derived from the security material, and/or may be signed using a cryptographic key that is included in the security material or derived from the security material. Other examples, however, may be implemented.

Items and/or techniques described herein may provide one or more of the following capabilities, as well as other capabilities not mentioned. Sensitive information contained in positioning signaling may be protected from being discovered by undesired entities. For discovery signaling, identity privacy and/or service identification/privacy may be provided, and/or fake service announcements/requests may be prevented from being acted upon. For pre-PRS messages, identity privacy may be provided, parameter leakage (e.g., from targeted/optimized attacks) may be inhibited (e.g., prevented), and/or parameter modification (resulting in denial of service (DoS) or service degradation) may be inhibited (e.g., prevented). Identity privacy may be provided for PRS responses. Positioning errors due to PRS injection may be inhibited (e.g., prevented), avoiding incorrect (over/under) range estimations. For post-PRS messages, location privacy may be provided and/or measurement result modification leading to location error may be inhibited (e.g., prevented). Other capabilities may be provided and not every implementation according to the disclosure must provide any, let alone all, of the capabilities discussed.

Obtaining the locations of mobile devices that are accessing a wireless network may be useful for many applications including, for example, emergency calls, personal navigation, consumer asset tracking, locating a friend or family member, etc. Existing positioning methods include methods based on measuring radio signals transmitted from a variety of devices or entities including satellite vehicles (SVs) and terrestrial radio sources in a wireless network such as base stations and access points. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, a UE may be any wireless communication device (e.g., a mobile phone, router, tablet computer, laptop computer, consumer asset tracking device, Internet of Things (IoT) device, etc.) used to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi® networks (e.g., based on IEEE (Institute of Electrical and Electronics Engineers) 802.11, etc.) and so on.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

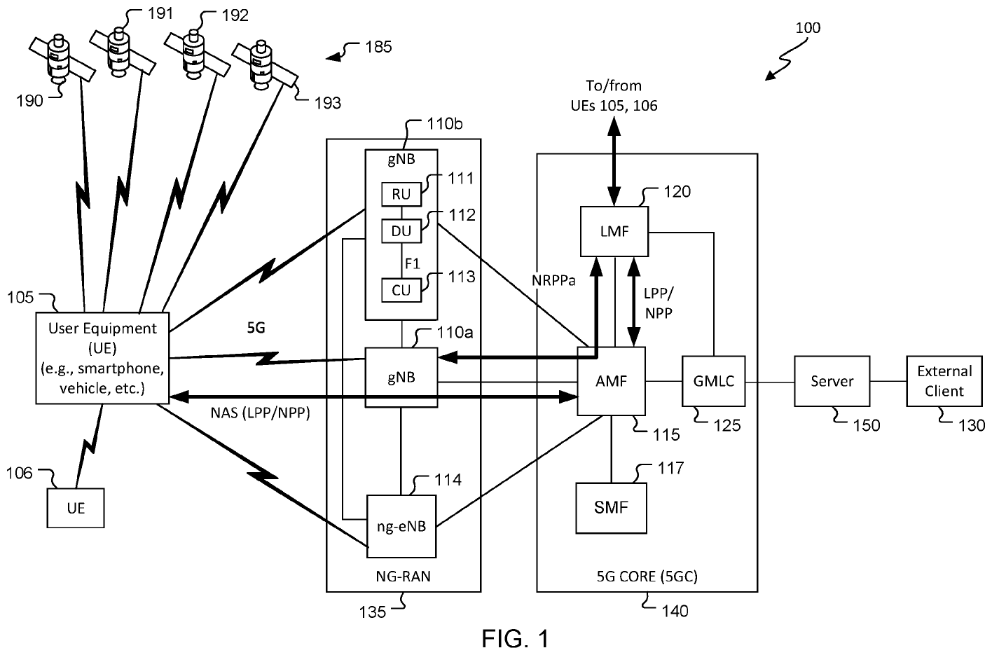

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or another device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi®, WiFi®-Direct (WiFi®-D), Bluetooth®, Bluetooth®-low energy (BLE), Zigbee®, etc. One or more base stations, e.g., one or more of the gNBs 110a, 110b and/or the ng-eNB 114 may be configured to communicate with the UE 105 via multiple carriers. Each of the gNBs 110a, 110b and/or the ng-eNB 114 may provide communication coverage for a respective geographic region, e.g., a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi® communication, multiple frequencies of Wi-Fi® communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi® (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH). Direct wireless-device-to-wireless-device communications without going through a network may be referred to generally as sidelink communications without limiting the communications to a particular protocol.

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi® (also referred to as Wi-Fi®), Bluetooth® (BT), Worldwide Interoperability for Microwave Access (WiMax®), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi® Direct (WiFi®-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g., the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110b includes an RU 111, a DU 112, and a CU 113. The RU 111, DU 112, and CU 113 divide functionality of the gNB 110b. While the gNB 110b is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110b. The DU 112 hosts the Radio Link Control (RLC), Medium Access Control (MAC), and physical layers of the gNB 110b. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110b. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g., by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi® AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi® access for the UE 105 and may comprise one or more WiFi® APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi® APs, an MME, and an E-SMLC.

As noted, in some embodiments, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the position of the UE.

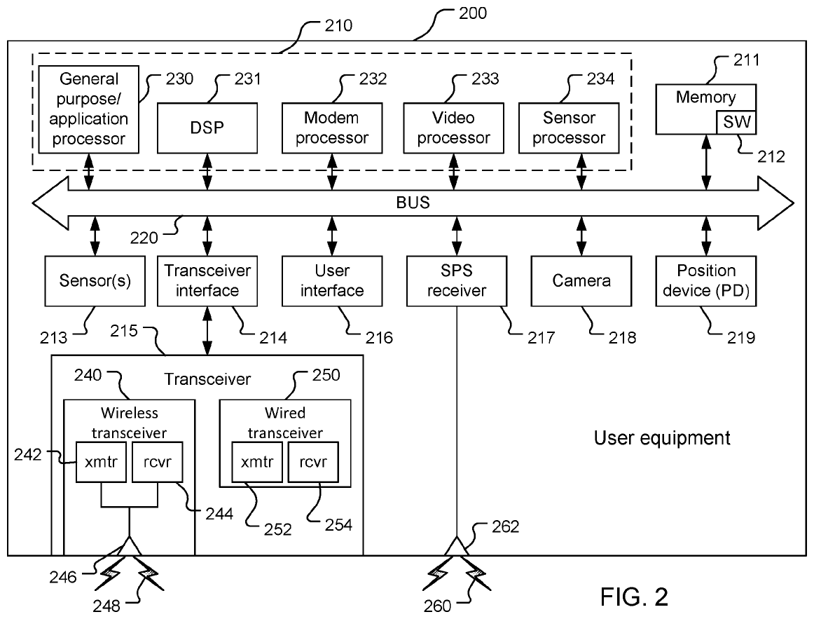

Referring also to FIG. 2, a UE 200 may be an example of one of the UEs 105, 106 and may comprise a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 may be a non-transitory storage medium that may include random access memory (RAM), flash memory, disc memory, and/or read-only memory (ROM), etc. The memory 211 may store the software 212 which may be processor-readable, processor-executable software code containing instructions that may be configured to, when executed, cause the processor 210 to perform various functions described herein. Alternatively, the software 212 may not be directly executable by the processor 210 but may be configured to cause the processor 210, e.g., when compiled and executed, to perform the functions. The description herein may refer to the processor 210 performing a function, but this includes other implementations such as where the processor 210 executes software and/or firmware. The description herein may refer to the processor 210 performing a function as shorthand for one or more of the processors 230-234 performing the function. The description herein may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations. The sensor(s) 213 may comprise one or more of other various types of sensors such as one or more optical sensors, one or more weight sensors, and/or one or more radio frequency (RF) sensors, etc.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and may report the relative displacement/distance (e.g., via dead reckoning, or sensor-based location determination, or sensor-assisted location determination enabled by the sensor(s) 213). In another example, for relative positioning information, the sensors/IMU may be used to determine the angle and/or orientation of the other device with respect to the UE 200, etc.

The IMU 270 may be configured to provide measurements about a direction of motion and/or a speed of motion of the UE 200, which may be used in relative location determination. For example, the one or more accelerometers 273 and/or the one or more gyroscopes 274 of the IMU 270 may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) 273 and the gyroscope(s) 274 taken after this moment in time may be used in dead reckoning to determine present location of the UE 200 based on movement (direction and distance) of the UE 200 relative to the reference location.

The magnetometer(s) 271 may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) 271 may include a three-dimensional magnetometer configured to detect and provide indications of magnetic field strength in three orthogonal dimensions. The magnetometer(s) 271 may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee® etc. New Radio may use mm-wave frequencies and/or sub-6 GHz frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the wireless signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

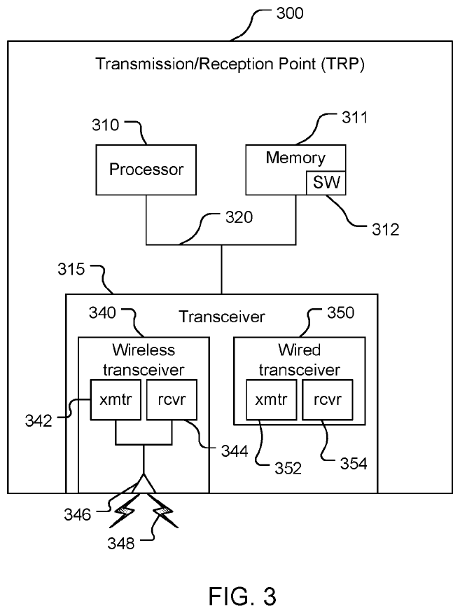

Referring also to FIG. 3, an example of a TRP 300 of the gNBs 110a, 110b and/or the ng-eNB 114 comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 may be a non-transitory storage medium that may include random access memory (RAM)), flash memory, disc memory, and/or read-only memory (ROM), etc. The memory 311 may store the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description herein may refer to the processor 310 performing a function, but this includes other implementations such as where the processor 310 executes software and/or firmware. The description herein may refer to the processor 310 performing a function as shorthand for one or more of the processors contained in the processor 310 performing the function. The description herein may refer to the TRP 300 performing a function as shorthand for one or more appropriate components (e.g., the processor 310 and the memory 311) of the TRP 300 (and thus of one of the gNBs 110a, 110b and/or the ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee® etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 may be configured to perform or performs several functions, but one or more of these functions may be performed by the LMF 120 and/or the UE 200 (i.e., the LMF 120 and/or the UE 200 may be configured to perform one or more of these functions).

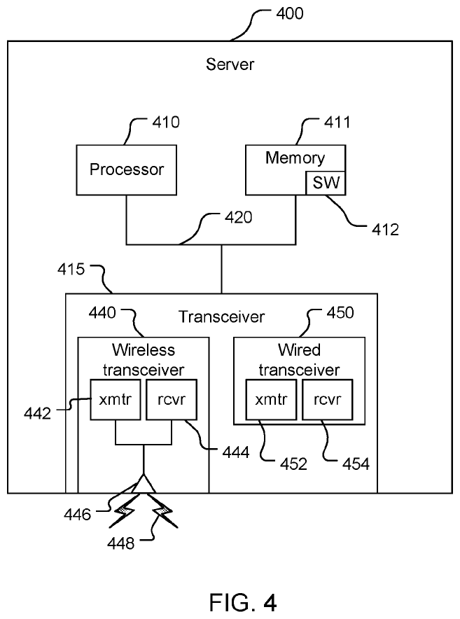

Referring also to FIG. 4, a server 400, of which the LMF 120 may be an example, may comprise a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 may be a non-transitory storage medium that may include random access memory (RAM)), flash memory, disc memory, and/or read-only memory (ROM), etc. The memory 411 may store the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description herein may refer to the processor 410 performing a function, but this includes other implementations such as where the processor 410 executes software and/or firmware. The description herein may refer to the processor 410 performing a function as shorthand for one or more of the processors contained in the processor 410 performing the function. The description herein may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee® etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

### Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_{Rx→Tx} (i.e., UE T_{Rx-Tx} or UE_{Rx-Tx}) between the ToA of the RTT measurement signal and the transmission time of the RTT response message in a payload of each RTT response message. The RTT response message would include a reference signal from which the base station can deduce the ToA of the RTT response. By comparing the difference T_{Tx→Rx} between the transmission time of the RTT measurement signal from the base station and the ToA of the RTT response at the base station to the UE-reported time difference T_{Rx→Tx}, and subtracting the UE_{Rx-Tx}, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS (Channel State Information-Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositzoningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every Nh resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource (or simply resource) can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (Base Transceiver Station) (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning being sent by UEs, and with PRS and SRS for positioning being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence). Position information may include one or more positioning signal measurements (e.g., of one or more satellite signals, of PRS, and/or one or more other signals), and/or one or more values (e.g., one or more ranges (possibly including one or more pseudoranges), and/or one or more position estimates, etc.) based on one or more positioning signal measurements.

### Sidelink Positioning Security

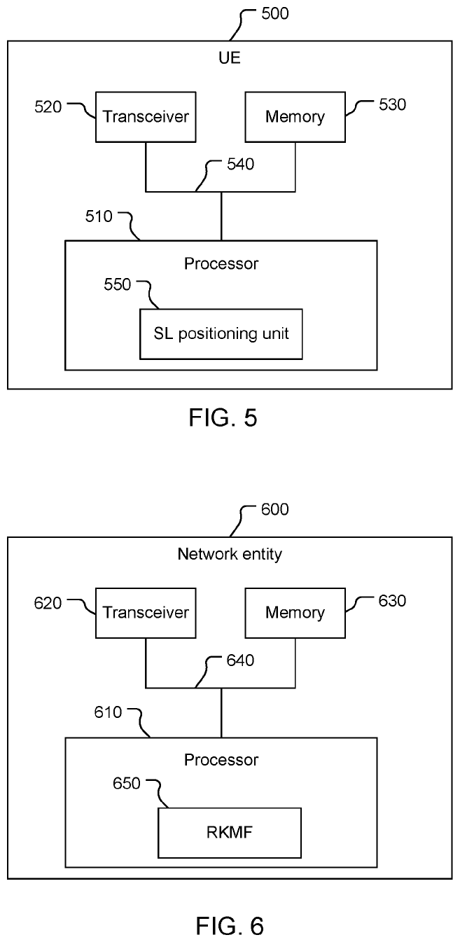

Referring also to FIG. 5, a UE 500 includes a processor 510, a transceiver 520, and a memory 530 communicatively coupled to each other by a bus 540. The UE 500 may include the components shown in FIG. 5. The UE 500 may include one or more other components such as any of those shown in FIG. 2 such that the UE 200 may be an example of the UE 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions.

The description herein may refer to the processor 510 performing a function, but this includes other implementations such as where the processor 510 executes software (stored in the memory 530) and/or firmware. The description herein may refer to the UE 500 performing a function as shorthand for one or more appropriate components (e.g., the processor 510 and the memory 530) of the UE 500 performing the function. The processor 510 (possibly in conjunction with the memory 530 and, as appropriate, the transceiver 520) includes an SL positioning unit 550. The SL positioning unit 550 is discussed further below, and the description may refer to the processor 510 generally, or the UE 500 generally, as performing any of the functions of the SL positioning unit 550. The UE 500 is configured to perform the functions of the SL positioning unit 550 discussed herein.

Referring also to FIG. 6, a network entity 600 includes a processor 610, a transceiver 620, and a memory 630 communicatively coupled to each other by a bus 640. The network entity 600 may include the components shown in FIG. 6. The network entity 600 may include one or more other components such as any of those shown in FIG. 3 and/or FIG. 4 such that the TRP 300 and/or the server 400 may be an example of the network entity 600. For example, the processor 610 may include one or more of the components of the processor 310 and/or the processor 410. The transceiver 620 may include one or more of the components of the transceiver 315 and/or the transceiver 415. The memory 630 may be configured similarly to the memory 311 and/or the memory 411, e.g., including software with processor-readable instructions configured to cause the processor 610 to perform functions.

The description herein may refer to the processor 610 performing a function, but this includes other implementations such as where the processor 610 executes software (stored in the memory 630) and/or firmware. The description herein may refer to the network entity 600 performing a function as shorthand for one or more appropriate components (e.g., the processor 610 and the memory 630) of the network entity 600 performing the function. The processor 610 (possibly in conjunction with the memory 630 and, as appropriate, the transceiver 620) includes an RKMF 650 (Ranging Key Management Function). The RKMF 650 is discussed further below, and the description may refer to the processor 610 generally, or the network entity 600 generally, as performing any of the functions of the RKMF 650. The network entity 600 is configured to perform the functions of the RKMF 650 discussed herein.

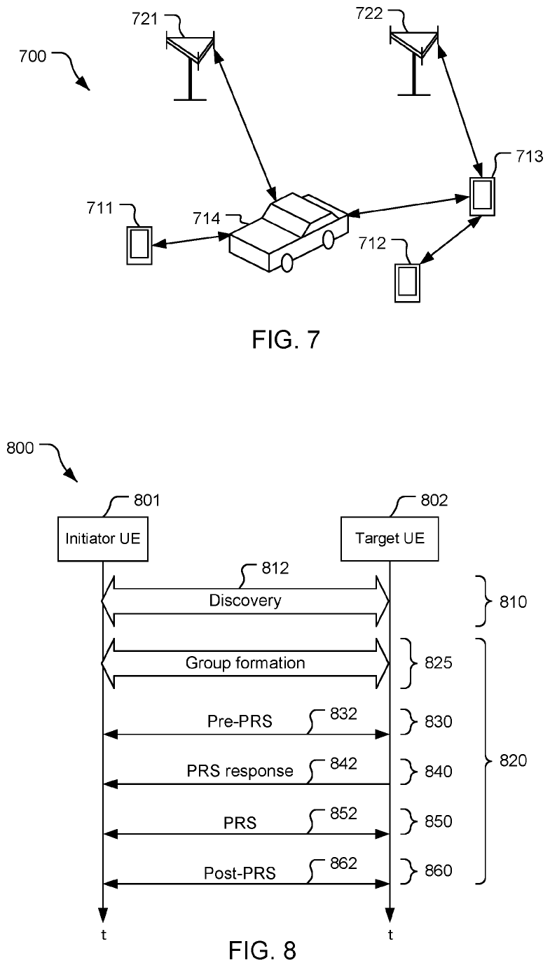

Referring also to FIG. 7, SL positioning can be performed in an environment 700 to determining ranges between UEs and/or locations of UEs. The ranges and/or locations of UEs may be used for one or more of a variety of reasons, such as collision avoidance, navigation, consumer asset tracking, selecting devices for emergency help requests, etc. The environment 700 includes UEs 711, 712, 713, 714 and base stations 721, 722. In this example, the UEs 711-713 are smartphones and the UE 714 is a vehicle, but these are examples and not limiting of the disclosure. The UEs 711-714 are configured to transfer SL signals via a PC5 interface for one or more purposes, e.g., positioning, communication, etc. While V2X and UE-to-UE use slightly different protocols, both use the PC5 link, which is the interface between UEs. The UEs 711-714 and the base stations 721, 722 are configured to communicate with each other through Uu interfaces.

Referring also to FIG. 8, a processing and signal flow 800 for SL positioning includes the stages shown, according to which any of the UEs 711-714 may engage in SL positioning with one or more of the other UEs 711-714. A UE, e.g., the UE 711, may engage in one-to-one positioning with one of the UEs 712-714 or may engage in one-to-N positioning, e.g., with all of the UEs 712-714, and the positioning may be coordinated by announcement-based handshaking or request-response handshaking between the UEs involved. As shown in FIG. 8, an initiator UE 801 engages in SL positioning with a target UE 802, with the target UE 802 being the UE whose position (e.g., relative to the UE 801 and/or relative to a reference coordinate system such as a coordinate system of Earth) is to be determined. The positioning process is divided into two portions, a discovery portion 810 and a positioning session portion 820.

The discovery portion 810 is optional and if included may be announcement discovery or request-response discovery. In announcement discovery, discovery messages 812 sent by the UEs 801, 802 are similar discovery messages that broadcast the capability of each UE to support SL positioning. In request-response discovery, the discovery messages 812 sent by the initiator UE 801 and the target UE 802 are different. The initiator UE 801 transmits (broadcasts) a PRS request for SL positioning support and the target UE 802 responds to receiving the PRS request by transmitting a PRS response indicating that the target UE 802 supports SL positioning. The signal transfer in both the discovery portion 810 and the positioning session portion 820 include privacy-sensitive information that is subject to tracking or targeted attacks if confidentiality protection is absent, and tamper-resistant-desired information that may lead to service downgrades or even denial of service if integrity/replay protection is absent. If signaling is unprotected, then privacy-sensitive information can be read and tamper-resistant-desired information can be sent by an attacker causing a downgrade or disruption (denial) of service. Confidentiality protection (e.g., encryption) can protect privacy-sensitive information while integrity protection can help ensure that information is from a trusted source or from the purported source or has not been altered, without keeping the information confidential. For announcement discovery messages, privacy-sensitive information includes, e.g., a V2X service identifier for SL positioning and UE source user information (e.g., an initiator ID), and tamper-resistant-desired information includes, e.g., a PRS carrier (e.g., licensed, unlicensed, ITS (Intelligent Transportation System)), and an indication of a capability of the UE to serve as an anchor UE (with a known location that may be used to help determine position of the target UE). For a PRS request message for request-response discovery, privacy-sensitive information includes, e.g., a V2X service identifier for SL positioning and UE source user information, and tamper-resistant-desired information includes, e.g., a PRS carrier, an indication of a capability of the UE to serve as an anchor UE, and a PRS format (e.g., comb number, number of symbols, TDM/FDM (Time Division Multiplexed/Frequency Division Multiplexed)). For a PRS response message for request-response discovery, privacy-sensitive information includes, e.g., a ranging session ID and a target application-layer ID, and tamper-resistant-desired information includes, e.g., a supported carrier for PRS and a desired range or position.

The positioning session portion 820 includes a group formation stage 825, a pre-PRS stage 830, a PRS response stage 840, a PRS stage 850, and a post-PRS stage 860. In the group formation stage 825, UEs that have been discovered communicate with each other to determine to form a group, which can be the basis for determining security information for protection of signaling between UEs in the group. For a pre-PRS message 832, privacy-sensitive information includes, e.g., an initiator-assigned session ID, an initiator ID, and a list of target UE ID(s), and tamper-resistant-desired information includes, e.g., PRS carrier, PRS periodicity, time duration for periodic PRS, an initiator UE earliest PRS Tx time, a PRS response required indication, and an anchor UE capability indication. For a PRS response message 842, privacy-sensitive information includes, e.g., a ranging session ID and a target application-layer ID, and tamper-resistant-desired information includes, e.g., a supported carrier for PRS and a desired range or position. PRS 852 does not include privacy-sensitive information or tamper-resistant-desired information, but may be protected to help guard against attacks, e.g., spoofing of the PRS. For a post-PRS response message 862, privacy-sensitive information includes, e.g., a ranging session ID and a target application-layer ID, and tamper-resistant-desired information includes, e.g., a list of PRS Rx-Tx differences (one for each initiator UE in the positioning session), a UE reference position, an offset of antenna from the UE reference position at PRS Tx time, a UE speed at PRS Tx time and associated accuracy, a UE acceleration at PRS Tx time and associated accuracy, and an angle of arrival for received PRS and associated accuracy.

The signals transferred in the flow 800 for ProSe (proximity services) devices are susceptible to various threats. A ProSe device is a device that supports the PC5 interface and signaling between UEs. The discovery messages, if sent, are broadcast, and the pre-PRS message 832, the PRS response message 842, the PRS 852, and the post-PRS message 862 may be broadcast (or groupcast) or unicast. Groupcast signaling may be managed or even based on distance, e.g., from a signal (e.g., message, PRS, etc.) source. The discovery messages 812 are susceptible to identity privacy, service identification/privacy, and fake service announcement/request attacks. The pre-PRS messages 832 are susceptible to identity privacy, parameter leakage (targeted/optimized), and parameter modification (DoS/service degradation) attacks. In a parameter leakage attack, the attacker is able to read the parameter(s) and use the parameter(s) to inject an attack message, e.g., with different parameter values. For example, an attacker can spoof a message and instruct a recipient to use different parameter values or may change (e.g., override) another message. The PRS response messages 842 are susceptible to identity privacy attacks. The PRS 852 are susceptible to PRS injection attacks, e.g., resulting in range (distance) over/under estimation. The post-PRS messages 862 are susceptible to location privacy attacks, and measurement result modification attacks (e.g., injection of an incorrect range) that may lead to location error. To combat message attacks, encryption, integrity protection, and/or replay protection may be used for broadcast and unicast messages. To combat PRS injection attacks, PRS signal randomization may be used. Depending on an application and/or scenario, confidentiality and/or integrity protection may be provided.

To provide security protection (e.g., confidentiality and/or integrity protection) for ranging/positioning signaling (including message transfer and/or non-message signal transfer), security material may be provisioned to UEs. The security material may include one or more cryptographic keys (e.g., one or more symmetric keys and/or one or more asymmetric keys) and/or one or more cryptographic certificates. The RKMF 650 is configured to provision security material to UEs for ranging services. The RKMF 650 may pre-provision security material to UEs before the UEs discover each other to form a group for positioning, or may provision security material on demand, e.g., in response to a request based on a group being formed for positioning. Security material may be provisioned for non-unicast message protection, i.e., broadcast message protection and/or multi-cast/groupcast message protection, e.g., without distinction between broadcast protection and multi-cast/groupcast protection. The discussion herein may refer to broadcast protection, and such discussion applies to multi-cast/groupcast protection as well.

For broadcast message protection, UEs (e.g., the UEs 801, 802) in a current PRS session share encryption and integrity protection keys. For example, the RKMF 650 may provision the keys to the UEs 801, 802 when each of the UEs 801, 802 is in coverage of the network entity 600, which may not occur concurrently. The network entity 600 may be, for example, a server in the 5GC 140 or an application server in the Internet. As another example, the protection keys may be established as part of a group formation process. In this case, the RKMF 650 may provision (before group formation or concurrently with group formation) the UEs 801, 802 with certificates that the UEs 801, 802 use to establish (e.g., derive) the protection keys, which may use more processing power than being provisioned with the protection keys by the RKMF 650 directly. UEs in the same group, e.g., the UEs 801, 802, may share the encryption and integrity keys. The keys may be pre-provisioned in advance of the group formation, and the risk of compromise of the keys grows as the group size grows. Group formation may occur after discovery and before establishment of one or more keys for protecting PRS transfer.

For broadcast PRS protection, the UEs in a PRS session may share a cryptographic key that is used to produce a PRS sequence. The UEs in the same group share the key that is used to produce the PRS sequence. The key and/or a freshness parameter (e.g., a timer, a counter, a system frame number, a slot number, a symbol number, or any combination of two or more thereof) and/or a base PRS may be used as one or more inputs to an algorithm to produce a sequence of randomized PRS. This may inhibit an attacker (or any entity without knowledge of the base PRS and the key) from injecting a PRS that one or more of the UEs in the group use to determine a range, and thus a location of the target UE. The cryptographic key may be provisioned similarly to the provisioning of the keys for broadcast message protection, e.g., on demand by the RKMF 650, in advance of group formation by the RKMF 650, or derived during group formation based on one or more certificates provisioned by the RKMF 650 in advance of, or concurrently with, group formation.

For unicast message and/or non-message signal protection, the UEs, e.g., the UEs 801, 802, may authenticate each other and establish a symmetric cryptographic key that is known only to the UEs 801, 802. A symmetric key may be used to provide confidentiality and integrity protection of signaling (e.g., messages and/or PRS) while an asymmetric private key may be used to provide integrity protection without confidentiality protection. An asymmetric private key may be used to sign a signal (e.g., message or PRS) to provide integrity protection, with a receiving entity using a public key, corresponding to the private key, to authenticate a received message. Cryptographic keys may be provisioned by the RKMF 650 during group formation or before group formation, with the UEs 801, 802 receiving the keys while connected to the network entity 600, although not necessarily concurrently. The RKMF 650 may pre-provision the cryptographic keys without knowledge of the UEs 801, 802 to be involved. In such case, numerous symmetric keys may be provisioned for the UEs 801, 802, each key corresponding to a particular other UE, such that the UEs 801, 802 will likely have the appropriate symmetric key when the UEs 801, 802 discover each other. Provisioning the keys on demand during group formation may help avoid storing a large quantity of keys because the desired UEs for the group are known. Public-key based cryptography may be used to provide scalability. The RKMF 650 may issue certificates to the UEs 801, 802, or endorse certificates issued by a trusted service (with a list of trusted certificate authorities provided to the UEs 801, 802), in advance of group formation. The certificates may be used by the UEs 801, 802 to determine a symmetric cryptographic key (e.g., as discussed further below). With a symmetric key established, a unicast link setup procedure for V2X as defined by 3GPP Technical Specification 33.536 may be used to establish a unicast link between the UEs 801, 802.

### Network Assisted/Managed Group Formation

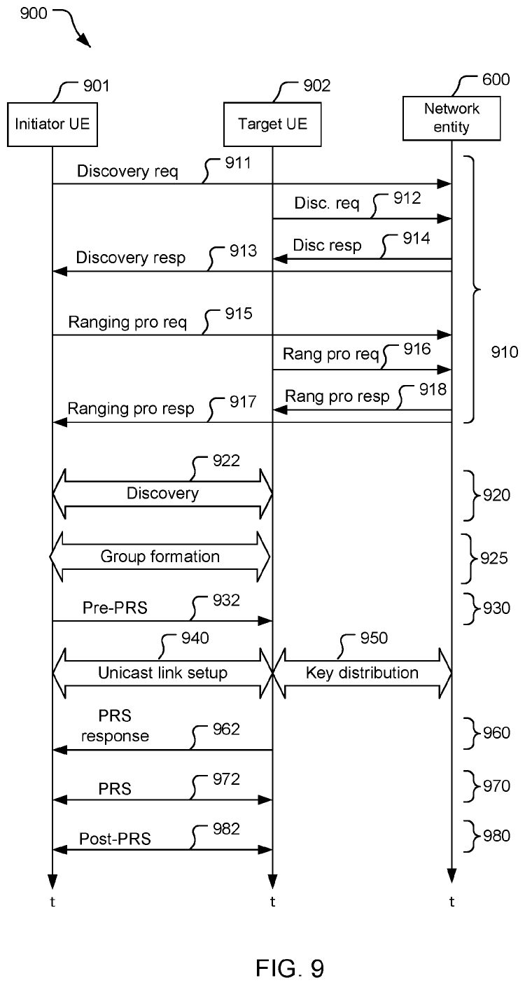

Referring also to FIG. 9, a processing and signal flow 900 for network assisted/managed group formation and broadcast or unicast SL positioning in the group includes the stages shown. The network entity 600, e.g., the RKMF 650, may assist an initiator UE 901 and a target UE 902 to form a group and have appropriate security material for confidentiality protecting and/or integrity protecting signaling during discovery and/or during a positioning session. The flow 900 is an example, and other flows may be used. For example, stage 940 may be omitted where broadcast/groupcast transmission of PRS response messages, PRS, and post-PRS messages is used instead of unicast transmission. As another example, stage 950 may be omitted where a ranging key for a unicast positioning session is not requested on demand.

At stage 910, the UEs 901, 902 are provisioned with appropriate security material. The UEs 901, 902 may send discovery requests 911, 912 to the network entity 600 requesting security material for discovery messages. The network entity 600, e.g., the RKMF 650, may respond to the discovery requests 911, 912 by sending discovery responses 913, 914 that include security material for discovery messages. Also or alternatively, the UEs 901, 902 may send ranging protection requests 915, 916 to the network entity 600 requesting security material for positioning signaling (including positioning messages and PRS). The network entity 600, e.g., the RKMF 650, may respond to the ranging protection requests 915, 916 by sending ranging protection responses 917, 918 that include security material for ranging messages and PRS. The same security material may be used for both discovery and ranging, or separate security materials may be provided for discovery and ranging. In some embodiments, discovery security material is provided while ranging security material is not. In some embodiments, ranging security material is provide and discovery security material is not.

The security material may be provided in advance of group formation or on demand. The security material may be provided before formation of the group comprising the UEs 901, 902, with the security material having a long validity time. The security material may be valid for one or more indicated areas, e.g., identified by a list of TAI (Tracking Area Identities) and/or one or more geographic locations and/or regions. If the security material is provided in advance of group formation, the UEs 901, 902 may be out of network coverage at group formation and/or during the positioning session (see the positioning session portion 820). For on demand provisioning of the security material, a UE (e.g., the UE 901 and/or the UE 902) requests the security material to join a positioning session. The UE (or a TRP and/or an AMF) may provide coarse location information for UE (e.g., a current TAC (Tracking Area Code), a current cell ID) to help the network entity 600 to form the group. The network entity 600, e.g., the RKMF 650, acts as a group manager for the UEs 901, 902 for on demand security material provisioning. The security material may be provided by the network entity 600 for a specific group, e.g., with different groups receiving different security material.

The security material may comprise one or more cryptographic keys and/or one or more digital certificates (which may be called cryptographic certificates or certificates). For example, the network entity 600 may provision the same symmetric cryptographic key (also called a symmetric key) for both the UEs 901, 902. As another example, the security material may include one or more cryptographic certificates (or simply, certificates) for one or more of the UEs 901, 902. Each digital certificate includes a public key (which may be called a public cryptographic key or a public asymmetric cryptographic key) and is associated with a private key (which may be called a private cryptographic key or a private asymmetric cryptographic key). For example, a respective UE may produce a public/private key pair and request a certificate by providing the public key to the network entity 600. The network entity 600 signs the certificate using the private key of the network entity 600. As another example, the network entity 600 may provision each of the UEs 901, 902 with a respective digital certificate (i.e., a public key of a UE signed by the network entity). The network entity 600 may produce the public/private key pair for a UE, sign the UE public key to produce a certificate, and provide the private key and the certificate to the UE. In this case, each certificate is a public key, of the respective UE, signed by the network entity 600 using the private key of the network entity 600. As another example, a manufacturer of the UE may produce or otherwise provide the public/private key and provision the keys for the UE during manufacture.

### Broadcast/Groupcast Signaling Protection

Broadcast messages may be provided with confidentiality and/or integrity protection where the UEs 901, 902 both have the same symmetric key. The confidentiality protection may be provided by security material provisioned by the network entity 600, e.g., the RKMF 650, in accordance with the 5G ProSe, 3GPP Technical Standard 33.503, for protecting signaling for mobile-to-mobile positioning. The security material is valid for the UEs in a group, e.g., the UEs 901, 902. The security material may comprise a DUSK (Discovery User Scrambling Key), a DUCK (Discovery User Confidentiality Key), and a DUIK (Discovery User Integrity Key). The DUSK, DUCK, and DUIK may be used to encrypt entire messages, to encrypt one or more portions of a message, and to protect the integrity of a message, respectively. Only UEs that have the DUCK can decipher the DUCK-ciphered portion(s) of a message. The DUIK may be used to protect the integrity of the entire message, e.g., with the transmitting UE signing the message with the DUIK and the receiving UE confirming the integrity using the DUIK. The DUSK, DUCK, and DUIK may be used to protect discovery messages 922 at a stage 920 and/or pre-PRS messages 932 at a stage 930 based on a group formed during a group formation stage 925. The same key may be used for discovery protection and pre-PRS protection, or a key (e.g., a group key) may be specifically for pre-PRS protection, with such a key not including the DUSK, DUCK, or DUIK. A group key (a cryptographic key provisioned for a group of UEs, e.g., by the network entity 600) may be used for groupcast protection. For example, the UEs 901, 902 may use the group key for AS-layer (Access Stratum layer) groupcast security, e.g., for public safety use cases. The AS-layer is a protocol layer between UE and gNB or between UE and UE over the air interface. The broadcast/groupcast key(s) used for pre-PRS protection may also be used to protect PRS response messages 962 at stage 960, PRS 972 transmitted at stage 970, and/or post-PRS messages 982 transmitted at stage 980 where a unicast link is not established or not used between the UEs 901, 902.

For broadcast or groupcast PRS transmission, a provisioned key may be used as a ranging key, to protect ranging signaling. For broadcast/groupcast ranging, the ranging key may be used to randomize the PRS. For example, the same group key may be used for discovery protection and for randomizing PRS. The SL positioning unit 550 of either of the UEs 901, 902 may use the group key and one or more other items (e.g., time (or frame number and/or slot number), group/service ID as inputs to a function to produce a PRS sequence for a positioning session. Each PRS in the sequence will be different and will be known to (produced by) each UE that has the group key, the function, and an understanding of the inputs to the function. The ranging key may, for example, be provided in the discovery responses 913, 914 or the ranging protection responses 917, 918, with the technique for randomizing the PRS being known by the UEs 901, 902. As another example, an indication of the technique for randomizing the PRS (and/or an indication of which inputs are to be used in the technique) may be indicated in the discovery responses 913, 914 and/or the ranging protection responses 917, 918.

### Unicast Signaling Protection

A unicast link may be established at stage 940 and a ranging cryptographic key, e.g., a symmetric key, established or otherwise obtained for protecting unicast signaling for mobile-to-mobile positioning at stages 960, 970, 980. The ranging cryptographic key may be called a PC5 ranging key as the key is used for protecting signaling over the PC5 interface between UEs. The ranging key may, for example, be obtained from the network entity 600 on demand, or obtained from the network entity 600 in advance of establishing the unicast link, or based on certificates of the UEs 901, 902.

For on-demand obtaining of the ranging key, the UE 902 communicates with the network entity 600 at stage 950 to request and receive the ranging key from the network entity 600, e.g., the RKMF 650. For example, during stage 940, the UE 902 sends a request to the UE 901 to have a unicast positioning session with the UE 901. The UE 901 responds by sending an instruction to the UE 902 for the UE 902 to request a ranging key from the network entity 600 for a unicast positioning session with the UE 901. At stage 950, with the UE 902 in coverage of the network to which the network entity 600 belongs, the SL positioning unit 550 of the UE 902 transmits a request to the network entity 600 for a ranging key for unicast ranging between the UE 902 and the UE 901. The network entity 600 responds by providing a ranging key, e.g., a Ranging Remote User Key (RRUK). The ranging key is a pairwise, symmetric key that is session-specific, e.g., for the UEs 901, 902 for the present time. The RKMF 650 knows a cryptographic key provisioned to the UE 901, and derives the ranging key from the key provisioned to the UE 901, and provides the ranging key to the UE 902. The SL positioning unit 550 of the UE 901 derives the ranging key from the cryptographic key previously provisioned by the RKMF 650 (while the UE 901 was in coverage of the network containing the network entity 600). The UEs 901, 902 transmit secret mode command messages to each other to confirm that both of the UEs 901, 902 have obtained (e.g., the UE 901 has derived and the UE 902 has received) the ranging key.

The ranging key may be pre-provisioned, being provided to the UEs 901, 902 in advance of stage 940. The network entity 600, or another entity, may provision each the UEs 901, 902 with multiple ranging keys for use in positioning session with respective UEs. In response to stage 940, the UE 901 may retrieve a ranging key from memory that is dedicated to a positioning session with the UE 902 and the UE 902 may retrieve a ranging key from memory that is dedicated to a positioning session with the UE 901.

The ranging key may be obtained by the UEs 901, 902 based on certificates of the UEs 901, 902. Each of the UEs 901, 902, when in coverage of the network containing the network entity 600, may receive a certificate from the network entity 600. The UEs 901, 902 may not be in coverage concurrently, or when the positioning session is being established. Each of the UEs 901, 902 sends the public key of the respective UE 901, 902 to the network entity 600. The network entity 600 signs the UE public key using the private key of the network entity 600 to form a certificate and sends the certificate to the respective UE 901, 902. Thus, each of the certificates contains the public key of the respective UE 901, 902 signed by a private asymmetric key of the network entity 600. The certificates may have one or more limitations on use, e.g., being limited to a specific geographic region and/or a specified time window. The UEs 901, 902 exchange their respective certificates. The UE 901 uses the public key of the network entity 600 to verify that the public key of the UE 902 in the received certificate is authentic and the UE 902 does the same for the public key of the UE 901. The SL positioning units 550 of the UEs 901, 902 use the verified public keys to derive (e.g., according to EAP-TLS (Extensible Authentication Protocol-Transport Layer Security) a symmetric key. The UEs 901, 902 may use this symmetric key to provide confidentiality and/or integrity protection to the positioning session, e.g., to the PRS response message 962, the PRS 972, and the post-PRS message 982. While the pre-PRS message 932 is shown going from the UE 901 to the UE 902, and the PRS response message 962 is shown going from the UE 902 to the UE 901, a pre-PRS message may be sent from the UE 902 to the UE 901, and a PRS response message may be sent from the UE 901 to the UE 902. Deriving the symmetric key in this was provides a scalable technique for determining symmetric keys for positioning sessions.

### UE-Based Autonomous Group Formation

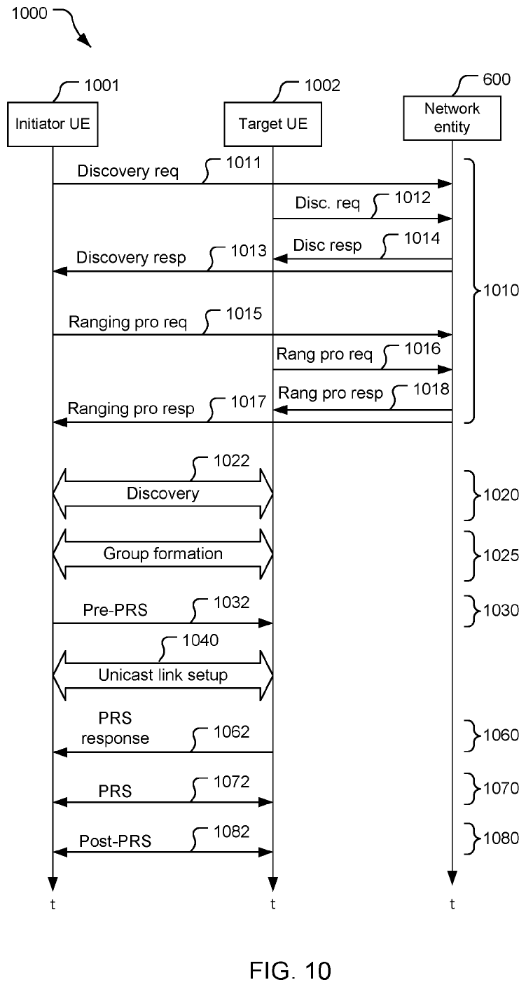

Referring also to FIG. 10, a processing and signal flow 1000 for UE-based group formation for an initiator UE 1001 and a target UE 1002, and broadcast or unicast SL positioning in the group includes the stages shown. The flow 1000 is an example, and other flows may be used. For example, stage 1040 may be omitted where broadcast/groupcast transmission of PRS response messages, PRS, and post-PRS messages is used instead of unicast transmission.

At stage 1010, the UEs 1001, 1002 are provisioned with appropriate security material. The UEs 1001, 1002 may send discovery requests 1011, 1012 to the network entity 600 requesting security material for discovery messages. The network entity 600, e.g., the RKMF 650, may respond to the discovery requests 1011, 1012 by sending discovery responses 1013, 1014 that include security material for discovery messages. Also or alternatively, the UEs 1001, 1002 may send ranging protection requests 1015, 1016 to the network entity 600 requesting security material for positioning signaling (including positioning messages and PRS). The network entity 600, e.g., the RKMF 650, may respond to the ranging protection requests 1015, 1016 by sending ranging protection responses 1017, 1018 that include security material for ranging messages and PRS. The network entity 600 may provision the UEs 1001, 1002 for autonomous group formation, or for both network-based group formation or autonomous group formation with an indication to use autonomous-based group formation when out of network coverage (and/or an indication to use network-based group formation when in network coverage). The same security material may be used for both discovery and ranging, or separate security material may be provided for discovery and ranging. In some embodiments, discovery security material is provided while ranging security material is not. In some embodiments, ranging security material is provide and discovery security material is not.

The security material is provided in advance of group formation and includes one or more certificates for each of the UEs 1001, 1002, with the security material having a long validity time. The certificates for the UEs 1001, 1002 respectively comprise a public key of the UE 1001 signed by the network entity 600 and a public key of the UE 1002 signed by the network entity 600. Multiple certificates may be provided for each of the UEs 1001, 1002, with a sequence for using the multiple certificates being known by the UEs 1001, 1002 (e.g., a protocol being pre-programmed, or being a local policy agreed to by the UEs 1001, 1002, e.g., during unicast link setup). Using multiple certificates and a certificate rollover protocol may help inhibit tracking of a UEs communications because use of a certificate by the UE 1001 (or the UE 1002) is visible to other entities, and the other entities may track communications by recognizing the same identity information and key ID in multiple communications. Changing the certificate makes tracking the communications for a UE more difficult. During stage 1010, the UEs 1001, 1002 may be provisioned with a trusted certificate authority (CA) list to assist with inter-operability with other service providers, e.g., other MNOs (Mobile Network Operators).

### Broadcast/Groupcast Signaling Protection

Broadcast messages may be provided with integrity or authenticity protection using provisioned certificates. For example, each broadcast message (e.g., each discover message 1022 at stage 1020, pre-PRS message 1032 at stage 1030, PRS response 1062 at stage 1060, PRS 1072 at stage 1070, and/or post-PRS message 1082 at stage 1080) sent by either of the UEs 1001, 1002 as appropriate is signed by the respective UE using the private key of the respective UE. A certificate (or a certificate chain) is carried in the message for verification by the receiving UE. The receiving UE verifies the message using the public key of the UE that transmitted the message, and uses the public key of the RKMF 650 to verify the public key of the transmitting UE. A group is formed at a group formation stage 1025 based on UEs that are aware of each other based on discovery at stage 1020, with the group being used to establish security information for signaling protection (e.g., group key establishment for broadcast/groupcast signal protection). Group formation occurs using the PC5 link without input from the network entity 600.

For broadcast or groupcast PRS transmission (for discovery and/or ranging), a provisioned key or a key derived from the provisioned key may be used as a ranging key, to protect ranging signaling. For broadcast/groupcast ranging, a group key (e.g., the ranging key) may be used to randomize the PRS, e.g., as discussed above (e.g., based on time (or frame number and/or slot number), group/service ID, and group key being used as inputs to a function to produce a PRS sequence for a positioning session), with the group key being obtained from the network entity 600 in the ranging protection responses 1017, 1018. Alternatively, the group key may be negotiated by the UEs 1001, 1002 during group formation, e.g., with a group leader (e.g., the initiator UE 1001) distributing a PRS session key after unicast link setup, e.g., with a group Diffie-Hellman key established during the group formation. For example, if a group key has not been provisioned by the network entity 600 or is not otherwise available, one UE may provision a group key to the other member(s) of the group over a secure unicast link for each other group member.

### Unicast Signaling Protection

A unicast link may be established at stage 1040 and a ranging cryptographic key, e.g., a symmetric key, established or otherwise obtained for protecting unicast signaling for mobile-to-mobile positioning at stages 1060, 1070, 1080. The ranging cryptographic key may be called a PC5 ranging key as the key is used for protecting signaling over the PC5 interface between UEs. The ranging key may, for example, be obtained based on certificates of the UEs 1001, 1002, similar to the discussion above for certificate-based key determination and protection for unicast transmissions (with the UEs 1001, 1002 providing the respective certificates to the other UE 1001, 1002 and determining a symmetric key based on the public keys of the UEs 1001, 1002).

### Operation

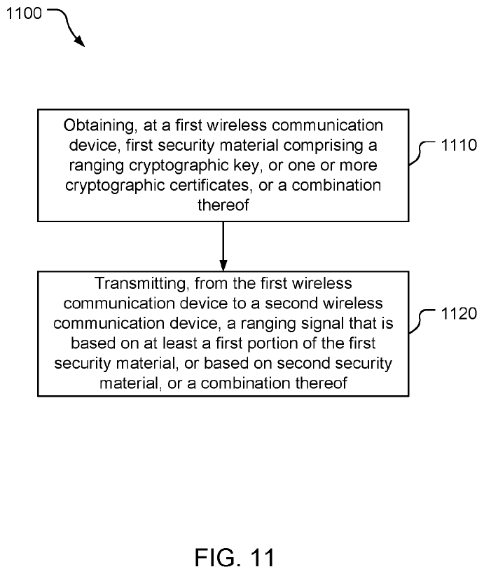

Referring to FIG. 11, with further reference to FIGS. 1-10, a positioning session signaling method 1100 includes the stages shown. The method 1100 is, however, an example and not limiting. The method 1100 may be altered, e.g., by having stages added, removed, rearranged, combined, performed concurrently, and/or having single stages split into multiple stages.

At stage 1110, the method 1100 includes obtaining, at a first wireless communication device, first security material comprising a ranging cryptographic key, or one or more cryptographic certificates, or a combination thereof. For example, the SL positioning unit 550 of the UE 500 (e.g., the UE 901, the UE 902, the UE 1001, or the UE 1002) may obtain security material (e.g., a symmetric key) via the transceiver 520 from the network entity 600 during stage 910 or 1010, e.g., in response to a request for the security material. The request may be sent by the first UE (e.g., the target UE 902) in response to a second UE (e.g., the initiator UE 901) instructing the first UE to contact the network entity 600 (e.g., the RKMF 650) to obtain the security material (e.g., a symmetric key). As another example, the SL positioning unit 550 may obtain the security material by retrieving the security material from the memory 530, e.g., with the security material having been previously received from the network entity 600 or pre-stored in the memory 530, e.g., during manufacture of the UE 500. The processor 510, possibly in combination with the memory 530, possibly in combination with the transceiver 520 (e.g., the wireless receiver 244 and the antenna 246) may comprise means for obtaining the first security material.

At stage 1120, the method 1100 includes transmitting, from the first wireless communication device to a second wireless communication device, a ranging signal that is based on at least a first portion of the first security material, or based on second security material, or a combination thereof. The first security material may be provisioned at stage 910 (on demand or in advance) and/or the second security material provisioned at stages 940, 950. For example, the UE 901 or the UE 902 may broadcast the PRS 972 based on a ranging key provisioned at stage 910, or provisioned at stage 950 for unicast signaling. The second security material may be provisioned on demand, or prior to group formation. The first portion of the first security information may be a discovery key that is used for ranging or may be a ranging-specific key. The ranging signal may be broadcast, groupcast, or unicast (e.g., if a unicast link is set up at stage 940 or stage 1040). The processor 510, possibly in combination with the memory 530, in combination with the transceiver 520 (e.g., the wireless transmitter 242 and the antenna 246) may comprise means for transmitting the ranging signal (and determining the ranging signal based on at least a first portion of the first security material and/or based on second security material).

Implementations of the method 1100 may include one or more of the following features. In an example implementation, the first security material comprises the ranging cryptographic key that is a symmetric cryptographic key, and the ranging signal comprises a modified positioning reference signal that is based on a base positioning reference signal and the ranging cryptographic key. For example, the modified PRS may be a base PRS (e.g., an initial PRS or a previous (e.g., most recent) PRS) that is randomized (e.g., with the previous PRS being the most recent randomized PRS in a chain of randomized PRS). The ranging cryptographic key may be the same key as a discovery cryptographic key. In another example implementation, the first security material comprises a first cryptographically-signed certificate comprising a first asymmetric cryptographic key, and the positioning session signaling method further comprises: transmitting, from the first wireless communication device to the second wireless communication device, the first cryptographically-signed certificate; and receiving, at the first wireless communication device from the second wireless communication device, a second cryptographically-signed certificate comprising a second asymmetric cryptographic key; where transmitting the ranging signal comprises transmitting the ranging signal as an encrypted unicast ranging signal that has been encrypted based on a symmetric cryptographic key that is based on the first asymmetric cryptographic key and the second asymmetric cryptographic key. For example, the first security material may be a certificate comprising a public key of the first UE (e.g., the UE 901, the UE 902, the UE 1001, or the UE 1002) signed by the private key of the RKMF 650. The UE (e.g., the UE 901) may be configured to transmit, and may transmit, the certificate to another UE (e.g., the UE 902), and may be configured to receive, and receive, a similar certificate from the other UE (of the public key of the other UE signed by the RKMF 650). The first UE can transmit the ranging signal encrypted using a symmetric key determined from the certificates (e.g., by using the public keys of the UEs as inputs to an algorithm, e.g., an EAP-TLS process). The processor 510, possibly in combination with the memory 530, in combination with the transceiver 520 (e.g., the wireless transmitter 242 and the antenna 246) may comprise means for transmitting the first cryptographically-signed certificate. The processor 510, possibly in combination with the memory 530, in combination with the transceiver 520 (e.g., the wireless receiver 244 and the antenna 246) may comprise means for receiving the second cryptographically-signed certificate. In a further example implementation, the first cryptographically-signed certificate is transmitted based on a present location of the first wireless communication device being within a validity region associated with the first cryptographically-signed certificate. For example, the SL positioning unit 550 may be configured not to transmit the certificate of the signed public key of the UE 500 unless the UE 500 is presently disposed in a region in which the UE 500 is certificate authorized for transmission by the UE 500.

Also or alternatively, implementations of the method 1100 may include one or more of the following features. In an example implementation, the method 1100 further comprises receiving, at the first wireless communication device from the second wireless communication device or a network entity, the ranging cryptographic key, and the second security material comprises the ranging cryptographic key. For example, at stage 950 the UE 902 receives a cryptographic key (e.g., a symmetric key) from the network entity 600. As another example, at stage 940 the UE 901 receives a cryptographic key from the UE 902 (that the UE 902 received from the network entity 600 at stage 950). The UE 901, 902 may use the ranging cryptographic key to protect (e.g., confidentiality protect by encrypting and/or security protect by signing) the ranging signal using the ranging cryptographic key. The processor 510, possibly in combination with the memory 530, possibly in combination with the transceiver 520 (e.g., the wireless receiver 244 and the antenna 246) may comprise means for receiving the ranging cryptographic key. In another example implementation, the method 1100 further comprises transmitting, from the first wireless communication device to the second wireless communication device, a discovery message that is based on at least a second portion of the first security material. The first and second portions of the first security material may be identical (e.g., a symmetric group key), or the first and second portions of the first security material could be any two of: a symmetric key; an asymmetric key; or a certificate. For example, the UE 902 may transmit a discovery message encrypted with a symmetric key, or that is signed using an asymmetric private key, or that includes a certificate. The processor 510, possibly in combination with the memory 530, possibly in combination with the transceiver 520 (e.g., the wireless transmitter 242 and the antenna 246) may comprise means for transmitting the discovery message (and encrypting and/or signing the discovery message). In a further example implementation, the first portion of the first security material is identical to the second portion of the first security material.

Also or alternatively, implementations of the method 1100 may include one or more of the following features. In an example implementation, the first security material comprises the ranging cryptographic key, and the positioning session signaling method further comprises: transmitting, from the first wireless communication device to the second wireless communication device, an indication for the second wireless communication device to contact a network entity for the ranging cryptographic key; and determining, at the first wireless communication device, the ranging cryptographic key based on a base cryptographic key stored at the first wireless communication device. For example, the initiator UE 901 transmits an indication to the target UE 902 during the stage 940, of unicast link setup, for the target UE 902 to contact the network entity 600 to obtain the ranging cryptographic key. The indication may include an ID of the initiator UE 901 and a freshness parameter, and may include an indication of a cryptographic key (e.g., a base key) provisioned to the initiator UE 901 by the network entity 600 (e.g., the RKMF 650). The initiator UE 901 may determine the ranging key based on the cryptographic key provisioned to the initiator UE 901 by the RKMF 650 and stored in the memory 530 and a protocol or algorithm known by both the initiator UE 901 and the RKMF 650 for which the base cryptographic key is used as an input. The base cryptographic key is stored by both the initiator UE 901 and the network entity 600. The base cryptographic key may be an initial key or may be a key that was previously derived from the initial key or another key in a chain of keys reaching back to the initial key. For example, first and second UEs want to have a symmetric key for unicast security between them. The first UE is provisioned with a base key. The first UE and the RKMF 650 use the base key and freshness parameters (e.g., a first random number produced by the first UE and a second random number produced by the RKMF 650) as inputs to a key derivation function (KDF) to determine the symmetric key. The first UE sends the first random number to the RKMF 650 and the RKMF 650 sends the second random number to the first UE. Both the first UE and the RKMF 650 may produce the symmetric key knowing the base key and the first and second random numbers. The processor 510, possibly in combination with the memory 530, possibly in combination with the transceiver 520 (e.g., the wireless transmitter 242 and the antenna 246) may comprise means for transmitting the indication for the second UE to contact the network entity for the ranging cryptographic key. The processor 510, possibly in combination with the memory 530, may comprise means for determining the ranging cryptographic key based on the base cryptographic key.

Also or alternatively, implementations of the method 1100 may include one or more of the following features. In an example implementation, the first security material comprises a plurality of cryptographically-signed certificates that include a public cryptographic key of the first wireless communication device cryptographically signed by an entity separate from the first wireless communication device and the second wireless communication device, and the positioning session signaling method further comprises transmitting, from the first wireless communication device to the second wireless communication device, a discovery message cryptographically signed by the first wireless communication device and comprising at least one of the plurality of cryptographically-signed certificates based on a certificate selection policy. For example, for autonomous group formation, the initiator UE 1001 may have multiple certificates stored in the memory 530 (with each certificate being a public key of the initiator UE 1001 signed by a private key of the network entity 600). At stage 1020, the initiator UE 1001 may send a discovery message 1022 signed by the initiator UE 1001 and including one or more of the certificates signed by the network entity 600. The certificate(s) in the discovery message 1022 may be selected by the initiator UE 1001 according to a certificate selection policy that is known to both of the UEs 1001, 1002. The processor 510, possibly in combination with the memory 530, possibly in combination with the transceiver 520 (e.g., the wireless transmitter 242 and the antenna 246) may comprise means for transmitting the discovery message to the second UE. In a further example implementation, the method 1100 further comprises the first wireless communication device negotiating the ranging cryptographic key with the second wireless communication device during group formation, and the ranging signal comprises a modified positioning reference signal that is based on a base positioning reference signal, or the ranging cryptographic key, or a freshness parameter, or a combination thereof, wherein the freshness parameter comprises a timer, a counter, a system frame number, a slot number, a symbol number, or any combination of two or more thereof. Thus, the base PRS, or the ranging cryptographic key, or the freshness parameter may be used as an input to an algorithm to produce a randomized PRS. Alternatively, the base PRS and the ranging cryptographic key, or the base PRS and the freshness parameter, or the ranging cryptographic key and the freshness parameter, or the base PRS and the ranging cryptographic key and the freshness parameter may be used as inputs to an algorithm to produce a randomized PRS. For example, the PRS transmitted by the initiator UE 1001 to the target UE 1002 (or from the target UE 1002 to the initiator UE 1001) may be randomized by using a cryptographic key negotiated by the UEs 1001, 1002 during group formation (where the UEs 1001, 1002 are determined to be a group for a positioning session) as at least one input to an algorithm for randomizing the PRS. A freshness parameter may also or alternatively be used as an input to the algorithm instead of or in addition to the key. The freshness parameter may be a timer, a counter, a system frame number, a slot number, a symbol number, or any combination of two or more thereof (e.g., a timer and a system frame number; or a counter, a slot number, and a symbol number; etc.). The processor 510, possibly in combination with the memory 530, possibly in combination with the transceiver 520 (e.g., the wireless transmitter 242, the wireless receiver 244, and the antenna 246) may comprise means for negotiating the ranging cryptographic key.

Also or alternatively, implementations of the method 1100 may include one or more of the following features. In an example implementation, the first security material is obtained in response to service establishment. For example, the first security material may be pre-provisioned and used when joining a PRS session. In another example implementation, the first security material is obtained in response to joining a ranging session. For example, the first security material may be obtained in response to the first wireless communication device joining an on-demand PRS session.

### Implementation Examples

Implementation examples are provided in the following numbered clauses.

Clause 1. A first wireless communication device comprising:
a transceiver;
a memory; and
a processor, communicatively coupled to the transceiver and the memory, configured to:
   obtain first security material comprising a ranging cryptographic key, or one or more cryptographic certificates, or a combination thereof; and
   transmit, via the transceiver to a second wireless communication device, a ranging signal that is based on at least a first portion of the first security material, or based on second security material, or a combination thereof.

Clause 2. The first wireless communication device of clause 1, wherein the first security material comprises the ranging cryptographic key that is a symmetric cryptographic key, and wherein the ranging signal comprises a modified positioning reference signal that is based on a base positioning reference signal and the ranging cryptographic key.

Clause 3. The first wireless communication device of clause 1, wherein the first security material comprises a first cryptographically-signed certificate comprising a first asymmetric cryptographic key, and wherein the processor is further configured to:
transmit, via the transceiver to the second wireless communication device, the first cryptographically-signed certificate; and
receive, via the transceiver from the second wireless communication device, a second cryptographically-signed certificate comprising a second asymmetric cryptographic key;
wherein to transmit the ranging signal the processor is configured to transmit the ranging signal as an encrypted unicast ranging signal that has been encrypted based on a symmetric cryptographic key that is based on the first asymmetric cryptographic key and the second asymmetric cryptographic key.

Clause 4. The first wireless communication device of clause 3, wherein the processor is configured to transmit the first cryptographically-signed certificate based on a present location of the first wireless communication device being within a validity region associated with the first cryptographically-signed certificate.

Clause 5. The first wireless communication device of clause 1, wherein the processor is further configured to receive, via the transceiver, the ranging cryptographic key, and wherein the second security material comprises the ranging cryptographic key.

Clause 6. The first wireless communication device of clause 1, wherein the processor is further configured to transmit, via the transceiver to the second wireless communication device, a discovery message that is based on at least a second portion of the first security material.

Clause 7. The first wireless communication device of clause 6, wherein the first portion of the first security material is identical to the second portion of the first security material.

Clause 8. The first wireless communication device of clause 1, wherein the first security material comprises the ranging cryptographic key, and the processor is further configured to:
transmit, via the transceiver to the second wireless communication device, an indication for the second wireless communication device to contact a network entity for the ranging cryptographic key; and
determine the ranging cryptographic key based on a base cryptographic key stored at the first wireless communication device.

Clause 9. The first wireless communication device of clause 1, wherein:
the first security material comprises a plurality of cryptographically-signed certificates that include a public cryptographic key of the first wireless communication device cryptographically signed by an entity separate from the first wireless communication device and the second wireless communication device; and
the processor is further configured to transmit, via the transceiver to the second wireless communication device, a discovery message cryptographically signed by the first wireless communication device and comprising at least one of the plurality of cryptographically-signed certificates based on a certificate selection policy.

Clause 10. The first wireless communication device of clause 9, wherein the processor is further configured to negotiate the ranging cryptographic key with the second wireless communication device during group formation, and wherein the ranging signal comprises a modified positioning reference signal that is based on a base positioning reference signal, or the ranging cryptographic key, or a freshness parameter, or a combination of two or more thereof, wherein the freshness parameter comprises a timer, a counter, a system frame number, a slot number, a symbol number, or any combination of two or more thereof.

Clause 11. The first wireless communication device of clause 1, wherein the processor is configured to obtain the first security material in response to service establishment.

Clause 12. The first wireless communication device of clause 1, wherein the processor is configured to obtain the first security material in response to joining a ranging session.

Clause 13. A positioning session signaling method comprising:
obtaining, at a first wireless communication device, first security material comprising a ranging cryptographic key, or one or more cryptographic certificates, or a combination thereof; and
transmitting, from the first wireless communication device to a second wireless communication device, a ranging signal that is based on at least a first portion of the first security material, or based on second security material, or a combination thereof.

Clause 14. The positioning session signaling method of clause 13, wherein the first security material comprises the ranging cryptographic key that is a symmetric cryptographic key, and wherein the ranging signal comprises a modified positioning reference signal that is based on a base positioning reference signal and the ranging cryptographic key.

Clause 15. The positioning session signaling method of clause 13, wherein the first security material comprises a first cryptographically-signed certificate comprising a first asymmetric cryptographic key, and wherein the positioning session signaling method further comprises:
transmitting, from the first wireless communication device to the second wireless communication device, the first cryptographically-signed certificate; and
receiving, at the first wireless communication device from the second wireless communication device, a second cryptographically-signed certificate comprising a second asymmetric cryptographic key;
wherein transmitting the ranging signal comprises transmitting the ranging signal as an encrypted unicast ranging signal that has been encrypted based on a symmetric cryptographic key that is based on the first asymmetric cryptographic key and the second asymmetric cryptographic key.

Clause 16. The positioning session signaling method of clause 15, wherein the first cryptographically-signed certificate is transmitted based on a present location of the first wireless communication device being within a validity region associated with the first cryptographically-signed certificate.

Clause 17. The positioning session signaling method of clause 13, further comprising receiving, at the first wireless communication device from the second wireless communication device or a network entity, the ranging cryptographic key, and wherein the second security material comprises the ranging cryptographic key.

Clause 18. The positioning session signaling method of clause 13, further comprising transmitting, from the first wireless communication device to the second wireless communication device, a discovery message that is based on at least a second portion of the first security material.

Clause 19. The positioning session signaling method of clause 18, wherein the first portion of the first security material is identical to the second portion of the first security material.

Clause 20. The positioning session signaling method of clause 13, wherein the first security material comprises the ranging cryptographic key, and the positioning session signaling method further comprises:
transmitting, from the first wireless communication device to the second wireless communication device, an indication for the second wireless communication device to contact a network entity for the ranging cryptographic key; and
determining, at the first wireless communication device, the ranging cryptographic key based on a base cryptographic key stored at the first wireless communication device.

Clause 21. The positioning session signaling method of clause 13, wherein:
the first security material comprises a plurality of cryptographically-signed certificates that include a public cryptographic key of the first wireless communication device cryptographically signed by an entity separate from the first wireless communication device and the second wireless communication device; and
the positioning session signaling method further comprises transmitting, from the first wireless communication device to the second wireless communication device, a discovery message cryptographically signed by the first wireless communication device and comprising at least one of the plurality of cryptographically-signed certificates based on a certificate selection policy.

Clause 22. The positioning session signaling method of clause 21, further comprising the first wireless communication device negotiating the ranging cryptographic key with the second wireless communication device during group formation, and wherein the ranging signal comprises a modified positioning reference signal that is based on a base positioning reference signal, or the ranging cryptographic key, or a freshness parameter, or a combination of two or more thereof, wherein the freshness parameter comprises a timer, a counter, a system frame number, a slot number, a symbol number, or any combination of two or more thereof.

Clause 23. The positioning session signaling method of clause 13, wherein the first security material is obtained in response to service establishment.

Clause 24. The positioning session signaling method of clause 13, wherein the first security material is obtained in response to joining a ranging session.

Clause 25. A first wireless communication device comprising:
means for obtaining first security material comprising a ranging cryptographic key, or one or more cryptographic certificates, or a combination thereof; and
means for transmitting, to a second wireless communication device, a ranging signal that is based on at least a first portion of the first security material, or based on second security material, or a combination thereof.

Clause 26. The first wireless communication device of clause 25, wherein the first security material comprises the ranging cryptographic key that is a symmetric cryptographic key, and wherein the ranging signal comprises a modified positioning reference signal that is based on a base positioning reference signal and the ranging cryptographic key.

Clause 27. The first wireless communication device of clause 25, wherein the first security material comprises a first cryptographically-signed certificate comprising a first asymmetric cryptographic key, and wherein the first wireless communication device further comprises:
means for transmitting, to the second wireless communication device, the first cryptographically-signed certificate; and
means for receiving, from the second wireless communication device, a second cryptographically-signed certificate comprising a second asymmetric cryptographic key;
wherein the means for transmitting the ranging signal comprises means for transmitting the ranging signal as an encrypted unicast ranging signal that has been encrypted based on a symmetric cryptographic key that is based on the first asymmetric cryptographic key and the second asymmetric cryptographic key.

Clause 28. The first wireless communication device of clause 27, wherein the means for transmitting the first cryptographically-signed certificate comprises means for transmitting the first cryptographically-signed certificate based on a present location of the first wireless communication device being within a validity region associated with the first cryptographically-signed certificate.

Clause 29. The first wireless communication device of clause 25, further comprising means for receiving, from the second wireless communication device or a network entity, the ranging cryptographic key, and wherein the second security material comprises the ranging cryptographic key.

Clause 30. The first wireless communication device of clause 25, further comprising means for transmitting, to the second wireless communication device, a discovery message that is based on at least a second portion of the first security material.

Clause 31. The first wireless communication device of clause 30, wherein the first portion of the first security material is identical to the second portion of the first security material.

Clause 32. The first wireless communication device of clause 25, wherein the first security material comprises the ranging cryptographic key, and the first wireless communication device further comprises:
means for transmitting, to the second wireless communication device, an indication for the second wireless communication device to contact a network entity for the ranging cryptographic key; and
means for determining the ranging cryptographic key based on a base cryptographic key stored at the first wireless communication device.

Clause 33. The first wireless communication device of clause 25, wherein:
the first security material comprises a plurality of cryptographically-signed certificates that include a public cryptographic key of the first wireless communication device cryptographically signed by an entity separate from the first wireless communication device and the second wireless communication device; and
the first wireless communication device further comprises means for transmitting, to the second wireless communication device, a discovery message cryptographically signed by the first wireless communication device and comprising at least one of the plurality of cryptographically-signed certificates based on a certificate selection policy.

Clause 34. The first wireless communication device of clause 33, further comprising means for negotiating the ranging cryptographic key with the second wireless communication device during group formation, and wherein the ranging signal comprises a modified positioning reference signal that is based on a base positioning reference signal, or the ranging cryptographic key, or a freshness parameter, or a combination of two or more thereof, wherein the freshness parameter comprises a timer, a counter, a system frame number, a slot number, a symbol number, or any combination of two or more thereof.

Clause 35. The first wireless communication device of clause 25, wherein the means for obtaining the first security material comprise means for obtaining the first security material in response to service establishment.

Clause 36. The first wireless communication device of clause 25, wherein the means for obtaining the first security material comprise means for obtaining the first security material in response to joining a ranging session.

Clause 37. A non-transitory, processor-readable storage medium comprising processor-readable instructions configured to cause a processor of a first wireless communication device to:
obtain first security material comprising a ranging cryptographic key, or one or more cryptographic certificates, or a combination thereof; and
transmit, to a second wireless communication device, a ranging signal that is based on at least a first portion of the first security material, or based on second security material, or a combination thereof.

Clause 38. The non-transitory, processor-readable storage medium of clause 37, wherein the first security material comprises the ranging cryptographic key that is a symmetric cryptographic key, and wherein the ranging signal comprises a modified positioning reference signal that is based on a base positioning reference signal and the ranging cryptographic key.

Clause 39. The non-transitory, processor-readable storage medium of clause 37, wherein the first security material comprises a first cryptographically-signed certificate comprising a first asymmetric cryptographic key, and wherein the processor-readable instructions further comprise processor-readable instructions configured to cause the processor to:
transmit, to the second wireless communication device, the first cryptographically-signed certificate; and
receive, from the second wireless communication device, a second cryptographically-signed certificate comprising a second asymmetric cryptographic key;
wherein the processor-readable instructions configured to cause the processor to transmit the ranging signal comprise processor-readable instructions configured to cause the processor to transmit the ranging signal as an encrypted unicast ranging signal that has been encrypted based on a symmetric cryptographic key that is based on the first asymmetric cryptographic key and the second asymmetric cryptographic key.

Clause 40. The non-transitory, processor-readable storage medium of clause 39, wherein the processor-readable instructions configured to cause the processor to transmit the first cryptographically-signed certificate comprises processor-readable instructions configured to cause the processor to transmit the first cryptographically-signed certificate based on a present location of the first wireless communication device being within a validity region associated with the first cryptographically-signed certificate.

Clause 41. The non-transitory, processor-readable storage medium of clause 37, wherein the processor-readable instructions further comprise processor-readable instructions configured to cause the processor to receive, from the second wireless communication device or a network entity, the ranging cryptographic key, and wherein the second security material comprises the ranging cryptographic key.

Clause 42. The non-transitory, processor-readable storage medium of clause 37, wherein the processor-readable instructions further comprise processor-readable instructions configured to cause the processor to transmit, to the second wireless communication device, a discovery message that is based on at least a second portion of the first security material.

Clause 43. The non-transitory, processor-readable storage medium of clause 42, wherein the first portion of the first security material is identical to the second portion of the first security material.

Clause 44. The non-transitory, processor-readable storage medium of clause 37, wherein the first security material comprises the ranging cryptographic key, and wherein the processor-readable instructions further comprise processor-readable instructions configured to cause the processor to:
transmit, to the second wireless communication device, an indication for the second wireless communication device to contact a network entity for the ranging cryptographic key; and
determine the ranging cryptographic key based on abase cryptographic key stored at the first wireless communication device.

Clause 45. The non-transitory, processor-readable storage medium of clause 37, wherein:
the first security material comprises a plurality of cryptographically-signed certificates that include a public cryptographic key of the first wireless communication device cryptographically signed by an entity separate from the first wireless communication device and the second wireless communication device; and
the processor-readable instructions further comprise processor-readable instructions configured to cause the processor to transmit, to the second wireless communication device, a discovery message cryptographically signed by the first wireless communication device and comprising at least one of the plurality of cryptographically-signed certificates based on a certificate selection policy.

Clause 46. The non-transitory, processor-readable storage medium of clause 45, wherein the processor-readable instructions further comprise processor-readable instructions configured to cause the processor to negotiate the ranging cryptographic key with the second wireless communication device during group formation, and wherein the ranging signal comprises a modified positioning reference signal that is based on a base positioning reference signal, or the ranging cryptographic key, or a freshness parameter, or a combination of two or more thereof, wherein the freshness parameter comprises a timer, a counter, a system frame number, a slot number, a symbol number, or any combination of two or more thereof.

Clause 47. The non-transitory, processor-readable storage medium of clause 37, wherein the processor-readable instructions configured to cause the processor to obtain the first security material comprise processor-readable instructions configured to cause the processor to obtain the first security material in response to service establishment.

Clause 48. The non-transitory, processor-readable storage medium of clause 37, wherein the processor-readable instructions configured to cause the processor to obtain the first security material comprise processor-readable instructions configured to cause the processor to obtain the first security material in response to joining a ranging session.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes one or more of such devices (e.g., “a processor” includes one or more processors, “the processor” includes one or more processors, “a memory” includes one or more memories, “the memory” includes one or more memories, etc.). The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication. A UE is a mobile wireless communication device and the term “UE” does not require a specific form of mobile wireless communication device beyond the description herein. The term “mobile” does not require a mobile wireless communication device to be in motion. A mobile wireless communication device is configured to be mobile, e.g., being lightweight and sized for transport, such as being a tablet computer or smartphone although a mobile wireless communication device is not limited to these forms of devices.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of 20% or ±10%, +5%, or +0.10% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of +20% or 10%, +5%, or +0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A first wireless communication device comprising:
a transceiver;
a memory; and
a processor, communicatively coupled to the transceiver and the memory, configured to:
obtain first security material comprising a ranging cryptographic key, or one or more cryptographic certificates, or a combination thereof; and
transmit, via the transceiver, to a second wireless communication device, a ranging signal that is based on at least a first portion of the first security material, or based on second security material, or a combination thereof.

2. The first wireless communication device of claim 1, wherein the first security material comprises the ranging cryptographic key that is a symmetric cryptographic key, and wherein the ranging signal comprises a modified positioning reference signal that is based on a base positioning reference signal and the ranging cryptographic key.

3. The first wireless communication device of claim 1, wherein the first security material comprises a first cryptographically-signed certificate comprising a first asymmetric cryptographic key, and wherein the processor is further configured to:
transmit, via the transceiver to the second wireless communication device, the first cryptographically-signed certificate; and
receive, via the transceiver from the second wireless communication device, a second cryptographically-signed certificate comprising a second asymmetric cryptographic key;
wherein to transmit the ranging signal the processor is configured to transmit the ranging signal as an encrypted unicast ranging signal that has been encrypted based on a symmetric cryptographic key that is based on the first asymmetric cryptographic key and the second asymmetric cryptographic key.

4. The first wireless communication device of claim 3, wherein the processor is configured to transmit the first cryptographically-signed certificate based on a present location of the first wireless communication device being within a validity region associated with the first cryptographically-signed certificate.

5. The first wireless communication device of claim 1, wherein the processor is further configured to receive, via the transceiver, the ranging cryptographic key, and wherein the second security material comprises the ranging cryptographic key.

6. The first wireless communication device of claim 1, wherein the processor is further configured to transmit, via the transceiver to the second wireless communication device, a discovery message that is based on at least a second portion of the first security material.

7. The first wireless communication device of claim 6, wherein the first portion of the first security material is identical to the second portion of the first security material.

8. The first wireless communication device of claim 1, wherein the first security material comprises the ranging cryptographic key, and the processor is further configured to:
transmit, via the transceiver to the second wireless communication device, an indication for the second wireless communication device to contact a network entity for the ranging cryptographic key; and
determine the ranging cryptographic key based on a base cryptographic key stored at the first wireless communication device.

9. The first wireless communication device of claim 1, wherein:
the first security material comprises a plurality of cryptographically-signed certificates that include a public cryptographic key of the first wireless communication device cryptographically signed by an entity separate from the first wireless communication device and the second wireless communication device; and
the processor is further configured to transmit, via the transceiver to the second wireless communication device, a discovery message cryptographically signed by the first wireless communication device and comprising at least one of the plurality of cryptographically-signed certificates based on a certificate selection policy.

10. The first wireless communication device of claim 9, wherein the processor is further configured to negotiate the ranging cryptographic key with the second wireless communication device during group formation, and wherein the ranging signal comprises a modified positioning reference signal that is based on a base positioning reference signal, or the ranging cryptographic key, or a freshness parameter, or a combination of two or more thereof, wherein the freshness parameter comprises a timer, a counter, a system frame number, a slot number, a symbol number, or any combination of two or more thereof.

11. A positioning session signaling method comprising:
obtaining, at a first wireless communication device, first security material comprising a ranging cryptographic key, or one or more cryptographic certificates, or a combination thereof; and
transmitting, from the first wireless communication device to a second wireless communication device, a ranging signal that is based on at least a first portion of the first security material, or based on second security material, or a combination thereof.

12. The positioning session signaling method of claim 11, wherein the first security material comprises the ranging cryptographic key that is a symmetric cryptographic key, and wherein the ranging signal comprises a modified positioning reference signal that is based on a base positioning reference signal and the ranging cryptographic key.

13. The positioning session signaling method of claim 11, wherein the first security material comprises a first cryptographically-signed certificate comprising a first asymmetric cryptographic key, and wherein the positioning session signaling method further comprises:
transmitting, from the first wireless communication device to the second wireless communication device, the first cryptographically-signed certificate; and
receiving, at the first wireless communication device from the second wireless communication device, a second cryptographically-signed certificate comprising a second asymmetric cryptographic key;
wherein transmitting the ranging signal comprises transmitting the ranging signal as an encrypted unicast ranging signal that has been encrypted based on a symmetric cryptographic key that is based on the first asymmetric cryptographic key and the second asymmetric cryptographic key.

14. The positioning session signaling method of claim 13, wherein the first cryptographically-signed certificate is transmitted based on a present location of the first wireless communication device being within a validity region associated with the first cryptographically-signed certificate.

15. The positioning session signaling method of claim 11, further comprising receiving, at the first wireless communication device from the second wireless communication device or a network entity, the ranging cryptographic key, and wherein the second security material comprises the ranging cryptographic key.

16. The positioning session signaling method of claim 11, further comprising transmitting, from the first wireless communication device to the second wireless communication device, a discovery message that is based on at least a second portion of the first security material.

17. The positioning session signaling method of claim 16, wherein the first portion of the first security material is identical to the second portion of the first security material.

18. The positioning session signaling method of claim 11, wherein the first security material comprises the ranging cryptographic key, and the positioning session signaling method further comprises:
transmitting, from the first wireless communication device to the second wireless communication device, an indication for the second wireless communication device to contact a network entity for the ranging cryptographic key; and
determining, at the first wireless communication device, the ranging cryptographic key based on a base cryptographic key stored at the first wireless communication device.

19. The positioning session signaling method of claim 11, wherein:
the first security material comprises a plurality of cryptographically-signed certificates that include a public cryptographic key of the first wireless communication device cryptographically signed by an entity separate from the first wireless communication device and the second wireless communication device; and
the positioning session signaling method further comprises transmitting, from the first wireless communication device to the second wireless communication device, a discovery message cryptographically signed by the first wireless communication device and comprising at least one of the plurality of cryptographically-signed certificates based on a certificate selection policy.

20. The positioning session signaling method of claim 19, further comprising the first wireless communication device negotiating the ranging cryptographic key with the second wireless communication device during group formation, and wherein the ranging signal comprises a modified positioning reference signal that is based on a base positioning reference signal, or the ranging cryptographic key, or a freshness parameter, or a combination of two or more thereof, wherein the freshness parameter comprises a timer, a counter, a system frame number, a slot number, a symbol number, or any combination of two or more thereof.

21. A first wireless communication device comprising:
means for obtaining first security material comprising a ranging cryptographic key, or one or more cryptographic certificates, or a combination thereof; and
means for transmitting, to a second wireless communication device, a ranging signal that is based on at least a first portion of the first security material, or based on second security material, or a combination thereof.

22. The first wireless communication device of claim 21, wherein the first security material comprises the ranging cryptographic key that is a symmetric cryptographic key, and wherein the ranging signal comprises a modified positioning reference signal that is based on a base positioning reference signal and the ranging cryptographic key.

23. The first wireless communication device of claim 21, wherein the first security material comprises a first cryptographically-signed certificate comprising a first asymmetric cryptographic key, and wherein the first wireless communication device further comprises:
means for transmitting, to the second wireless communication device, the first cryptographically-signed certificate; and
means for receiving, from the second wireless communication device, a second cryptographically-signed certificate comprising a second asymmetric cryptographic key;
wherein the means for transmitting the ranging signal comprises means for transmitting the ranging signal as an encrypted unicast ranging signal that has been encrypted based on a symmetric cryptographic key that is based on the first asymmetric cryptographic key and the second asymmetric cryptographic key.

24. The first wireless communication device of claim 23, wherein the means for transmitting the first cryptographically-signed certificate comprises means for transmitting the first cryptographically-signed certificate based on a present location of the first wireless communication device being within a validity region associated with the first cryptographically-signed certificate.

25. The first wireless communication device of claim 21, further comprising means for receiving, from the second wireless communication device or a network entity, the ranging cryptographic key, and wherein the second security material comprises the ranging cryptographic key.

26. The first wireless communication device of claim 21, further comprising means for transmitting, to the second wireless communication device, a discovery message that is based on at least a second portion of the first security material.

27. The first wireless communication device of claim 26, wherein the first portion of the first security material is identical to the second portion of the first security material.

28. The first wireless communication device of claim 21, wherein the first security material comprises the ranging cryptographic key, and the first wireless communication device further comprises:
means for transmitting, to the second wireless communication device, an indication for the second wireless communication device to contact a network entity for the ranging cryptographic key; and
means for determining the ranging cryptographic key based on a base cryptographic key stored at the first wireless communication device.

29. The first wireless communication device of claim 21, wherein:
the first security material comprises a plurality of cryptographically-signed certificates that include a public cryptographic key of the first wireless communication device cryptographically signed by an entity separate from the first wireless communication device and the second wireless communication device; and
the first wireless communication device further comprises means for transmitting, to the second wireless communication device, a discovery message cryptographically signed by the first wireless communication device and comprising at least one of the plurality of cryptographically-signed certificates based on a certificate selection policy.

30. A non-transitory, processor-readable storage medium comprising processor-readable instructions configured to cause a processor of a first wireless communication device to:
obtain first security material comprising a ranging cryptographic key, or one or more cryptographic certificates, or a combination thereof; and
transmit, to a second wireless communication device, a ranging signal that is based on at least a first portion of the first security material, or based on second security material, or a combination thereof.
